(19) United States
(12) Patent Application Publication
(10) Pub. No.: US 2023/0193934 A1
(43) Pub. Date: Jun. 22, 2023

(54) PRESS-FIT STRUCTURE AND PRESS-FIT METHOD THEREOF

(71) Applicant: DTECH PRECISION INDUSTRIES CO., LTD., New Taipei City (TW)

(72) Inventor: TING-JUI WANG, New Taipei City (TW)

(21) Appl. No.: 17/883,644

(22) Filed: Aug. 9, 2022

(30) Foreign Application Priority Data
Dec. 22, 2021 (TW) 110148127

(51) Int. Cl. F16B 4/00; B21D 22/20; B21D 22/26

(52) U.S. Cl. CPC F16B 4/004; B21D 22/201; B21D 22/26

(57) ABSTRACT

A press-fit structure and a press-fit method are introduced. The press-fit structure includes a body, a pressurizing portion, a material storage space, a restricting portion and a limit stop portion. The pressurizing portion is for applying a pressure on an object to cause a material of the object to flow into or enter the material storage space. The object is restricted by the restricting portion, and a restriction direction of the press-fit structure is restricted by the limit stop portion. Thus, the press-fit structure and the press-fit method of the present disclosure are enabled to provide a required object with a stable assembly effect.

### CROSS-REFERENCE TO RELATED APPLICATION

This non-provisional application claims priority under 35 U.S.C. § 119(a) on Patent Application No(s). 110148127 filed in Taiwan, R.O.C. on Dec. 22, 2021, the entire contents of which are hereby incorporated by reference.

### BACKGROUND OF THE INVENTION

### 1. Field of the Invention

The present disclosure provides a press-fit structure and a press-fit method thereof, and in particular to a press-fit structure capable of providing a required object with stable assembly and a press-fit method thereof.

### 2. Description of the Related Art

When at least one object is to be coupled, a fastener is usually used for the coupling. However, due to a structural design of the fastener, the coupled object may become unstable and even become loose.

### BRIEF SUMMARY OF THE INVENTION

In view of the prior art above, the inventor has developed a press-fit structure and a press-fit method thereof, in the aim of achieving an object of providing a required object with stable assembly.

To achieve the above and other objects, the present disclosure provides a press-fit structure. The press-fit structure includes a body, a pressurizing portion, a material storage space, a restricting portion and a limit stop portion. The pressurizing portion, the material storage space, the restricting portion and the limit stop portion are provided at the body. The pressurizing portion is for applying a pressure on an object to cause a material of the object to flow into or enter the material storage space. The press-fit structure restricts the object by the restricting portion, and a restriction direction of the press-fit structure is restricted by the limit stop portion.

The present disclosure further provides a press-fit method for a press-fit structure. The press-fit method includes: first arranging the pressuring portion on a pressurizing position of the object such that the limit stop portion is located at a corresponding stop portion of the object or a mold, and pressurizing the press-fit structure by an external force such that the press-fit structure is press-fitted at the object and limited by the limit stop portion.

The present disclosure further provides a press-fit method for a press-fit structure. The press-fit method includes: first arranging the pressuring portion on a pressurizing position at an upper surface of the object such that the limit stop portion is located at a corresponding stop portion of the object, and pressurizing the press-fit structure by an external force such that the press-fit structure is press-fitted at the object and limited by the limit stop portion.

In the above press-fit structure and press-fit method thereof, the press-fit structure further includes a fastening portion. The fastening portion is provided at the body, and the limit stop portion restricts a direction of the fastening portion or a fastening direction of the fastening portion.

In the above press-fit structure and press-fit method thereof, the press-fit structure further includes a fastening portion. The fastening portion is a through hole, an inner thread, an outer thread, a column, an outer fastener, an inner fastener, an elastic fastener, a lateral fastener, or a fastening portion having a neck, or the fastening portion is a fastener movably connected to the body.

In the above press-fit structure and press-fit method thereof, the fastening portion is a fastener movably connected to the body.

In the above press-fit structure and press-fit method thereof, the object has a corresponding stop portion, and the corresponding stop portion correspondingly stops against the limit stop portion.

In the above press-fit structure and press-fit method thereof, the press-fit structure further includes a fastening portion, the object has a corresponding stop portion, and the limit stop portion and the corresponding stop portion define a fastening direction, a fastening position, an operating direction or an operating position of the fastening portion.

In the above press-fit structure and press-fit method thereof, the object has a corresponding stop portion, and the corresponding stop portion and the limit stop portion have a press-fit gap in between.

In the above press-fit structure and press-fit method thereof, the press-fit gap ranges between 0.00000000001 mm and 100 mm.

In the above press-fit structure and press-fit method thereof, the object is made of a metal material or a plastic material.

In the above press-fit structure and press-fit method thereof, the press-fit structure is made of a metal material or stainless steel material that has undergone heat treating.

In the above press-fit structure and press-fit method thereof, an amount of the material of the object pressed into the material storage space ranges between 0.0001 g and 500 g.

In the above press-fit structure and press-fit method thereof, the limit stop portion is a single-cut surface, a double-cut edge, a symmetrical cut edge, a multi-cut surface, a convex portion, a concave portion, a flat portion, an inclined portion, a curved portion, a toothed portion or a stepped portion.

In the above press-fit structure and press-fit method thereof, the pressurizing portion is greater than the material storage space, the material storage space is smaller than the restricting portion, and the restricting portion is smaller than the pressurizing portion.

In the above press-fit structure and press-fit method thereof, the press-fit structure further includes a handle.

In the above press-fit structure and press-fit method thereof, the object has a corresponding stop portion, and a gap between the limit stop portion and the corresponding stop portion is smaller than a gap between the restricting portion and a part that is not the corresponding stop portion in an opening of the object, and is for restricting a fastening direction or a fastened direction of a fastening portion or restricting a true position or an angle of a fastening position or a fastened position of a fastening portion.

In the above press-fit structure and press-fit method thereof, the limit stop portion and the object have respective corresponding stop portions for mutually correspondingly performing anti-rotation or preventing anti-rotation.

In the above press-fit structure and press-fit method thereof, the press-fit structure further includes a fastening portion. The fastening portion has a neck, and the neck has a limit portion for restricting a fastening direction of a corresponding limit portion of a fastening counterpart.

In the above press-fit structure and press-fit method thereof, the press-fit structure further includes a fastening portion. The fastening portion has a limit portion for restricting a fastening direction of a corresponding limit portion of a fastening counterpart.

In the above press-fit structure and press-fit method thereof, the press-fit structure further includes a fastening portion, which is movably disposed at the body.

In the above press-fit structure and press-fit method thereof, the limit stop portion is for correspondingly stopping against a corresponding stop portion of a mold, so as to restrict a restriction direction of the press-fit structure by the limit stop portion.

In the above press-fit structure and press-fit method thereof, the press-fit structure further includes a fastening portion. The fastening portion has an anti-rotation portion, which is for restricting an anti-rotation direction or a fastening direction of a corresponding anti-rotation portion of a fastening counterpart.

Thus, the press-fit structure and the press-fit method of the present disclosure are capable of providing a required object with stable assembly effect.

### BRIEF DESCRIPTION OF THE DRAWINGS

FIG. 1 is a side view of a press-fit structure according to a first embodiment of the present disclosure.

FIG. 2 is a top view of a press-fit structure according to the first embodiment of the present disclosure.

FIG. 3 is a schematic diagram of a press-fitted state of a press-fit structure according to the first embodiment of the present disclosure.

FIG. 4 is a top view of a press-fit structure according to a second embodiment of the present disclosure.

FIG. 5 is a top view of a press-fit structure according to a third embodiment of the present disclosure.

FIG. 6 is an appearance schematic diagram of a press-fit structure according to a fourth embodiment of the present disclosure.

FIG. 7 is a schematic diagram of a press-fitted state of a press-fit structure according to the fourth embodiment of the present disclosure.

FIG. 8 is an appearance schematic diagram of a press-fit structure according to a fifth embodiment of the present disclosure.

FIG. 9 is a schematic diagram of a press-fitted state of a press-fit structure according to the fifth embodiment of the present disclosure.

FIG. 10 is a schematic diagram of a press-fitted state of a press-fit structure according to a sixth embodiment of the present disclosure.

FIG. 11 is a side view of a press-fit structure according to a seventh embodiment of the present disclosure.

FIG. 12 is a schematic diagram of different forms of a fastening portion of a press-fit structure according to the present disclosure.

FIG. 13 is a schematic diagram of a press-fitted state of a press-fit structure according to an eighth embodiment of the present disclosure.

FIG. 14 is a schematic diagram of a press-fitted state of a press-fit structure according to a ninth embodiment of the present disclosure.

FIG. 15 is a schematic diagram of a press-fitted state of a press-fit structure according to a tenth embodiment of the present disclosure.

FIG. 16 is a schematic diagram of a press-fitted state of a press-fit structure according to an eleventh embodiment of the present disclosure.

FIG. 17 is a schematic diagram of a press-fitted state of a press-fit structure according to a twelfth embodiment of the present disclosure.

FIG. 18 is a schematic diagram of a press-fitted state of a press-fit structure according to a thirteenth embodiment of the present disclosure.

FIG. 19 is a schematic diagram of a press-fitted state of a press-fit structure according to a fourteenth embodiment of the present disclosure.

FIG. 20 is a schematic diagram of a state of use of a press-fit structure according to the fourteenth embodiment of the present disclosure.

FIG. 21 is a schematic diagram of a press-fitted state of a press-fit structure according to a fifteenth embodiment of the present disclosure.

FIG. 22 is a schematic diagram of a press-fitted state of a press-fit structure according to the fifteenth embodiment of the present disclosure.

FIG. 23 is a first schematic diagram of a press-fitted state of a press-fit structure according to a sixteenth embodiment of the present disclosure.

FIG. 24 is a second schematic diagram of a press-fitted state of a press-fit structure according to the sixteenth embodiment of the present disclosure.

FIG. 25 is a first schematic diagram of a press-fitted state of a press-fit structure according to a seventeenth embodiment of the present disclosure.

FIG. 26 is a second schematic diagram of a press-fitted state of a press-fit structure according to the seventeenth embodiment of the present disclosure.

### DETAILED DESCRIPTION OF THE INVENTION

To fully understand the objects, features and effects of the present disclosure, the present disclosure is described in detail by way of the specific embodiments with the accompanying drawings below.

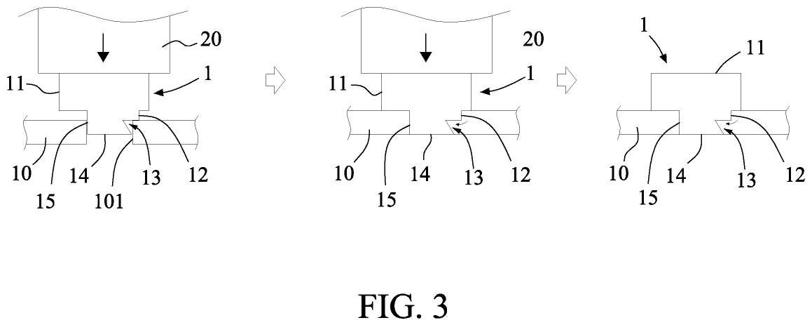

Refer to FIG. 1 to FIG. 5 showing a press-fit structure 1 of the present disclosure. The press-fit structure 1 includes a body 11, a pressurizing portion 12, a material storage space 13, a restricting portion 14 and a limit stop portion 15. The pressurizing portion 12, the material storage space 13, the restricting portion 14 and the limit stop portion 15 are provided at the body 11. In a preferred embodiment of the present disclosure, the pressurizing portion 12 is provided at a lower part of the body 11, the material storage space 13 is provided below the pressurizing portion 12, the restricting portion 14 is provided below the material storage space 13, and the limit stop portion 15 is provided on one side of the lower part of the body 11. The pressurizing portion 12 is for applying a pressure on an object 10 to cause a material of the object 10 to flow into or enter the material storage space 13, the press-fit structure 1 restricts the object 10 by the restricting portion 14, and a restriction direction of the press-fit structure 1 is restricted by the limit stop portion 15.

In the press-fit method of a press-fit structure of the present disclosure, the pressurizing portion 12 of the press-fit structure 1 can be first arranged at a pressurizing position of the object 10. For example, the press-fit structure 1 is arranged at a pressurizing position at an upper surface of the object 10, such that the limit stop portion 15 is located at a corresponding stop portion 101 of the object 10 (or a mold). The body 11 of the press-fit structure 1 is pressurized by an external force using a pressurizing mold 20, such that the press-fit structure 1 is press-fitted at the object 10 and is limited by the limit stop portion 15. When the press-fit structure 1 is press-fitted at the object 10, the material of the object 10 is allowed to flow into or enter the material storage space 13, the object 10 is restricted by the restricting portion 14, and the corresponding stop portion 101 and the limit stop portion 15 are correspondingly stopped, so as to restrict a restriction direction of the press-fit structure 1 by the limit stop portion 15. Thus, the press-fit structure 1 and the required object 10 are provided with a stable assembly effect.

In one embodiment of the present disclosure, the object 10 is made of a metal material or a plastic material. Thus, the press-fit structure 1 can be assembled onto the object 10 in various materials as needed, so as to meet actual application requirements.

In one embodiment of the present disclosure, the press-fit structure 1 may be made of a metal material or stainless steel material that has undergone heat treating. Thus, the press-fit structure 1 can be made of a selected material as needed, so as to meet actual application requirements.

In one embodiment of the present disclosure, an amount of the material of the object 10 pressed into the material storage space 13 ranges between 0.0001 g and 500 g. Thus, the material of the object 10 can flow into or enter the material storage space 13, the object 10 can be restricted by the restricting portion 14, and the restriction direction of the press-fit structure 1 can be restricted by the limit stop portion 15. Thus, the press-fit structure 1 and the required object 10 are provided with a stable assembly effect.

In one embodiment of the present disclosure, the limit stop portion 15 is a single-cut surface, a double-cut edge, a symmetrical cut edge, a multi-cut surface, a convex portion, a concave portion, a flat portion, an inclined portion, a curved portion, a toothed portion or a stepped portion. Thus, the limit stop portion 15 in different forms can be selected according to requirements of the object 10, so as to provide the press-fit structure 1 and the required object 10 with a stable assembly effect.

In one embodiment of the present disclosure, in addition to the forms in

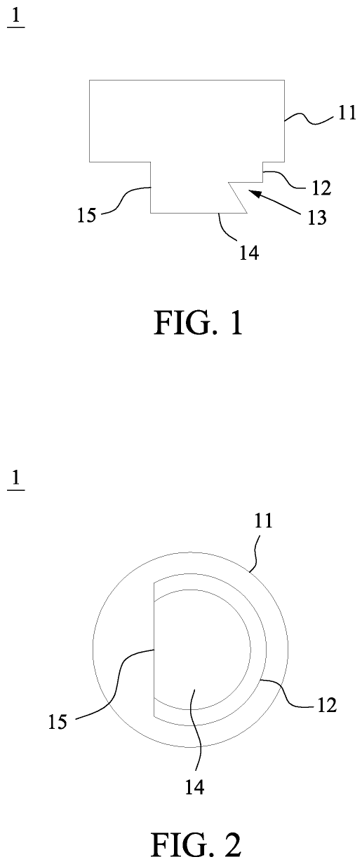

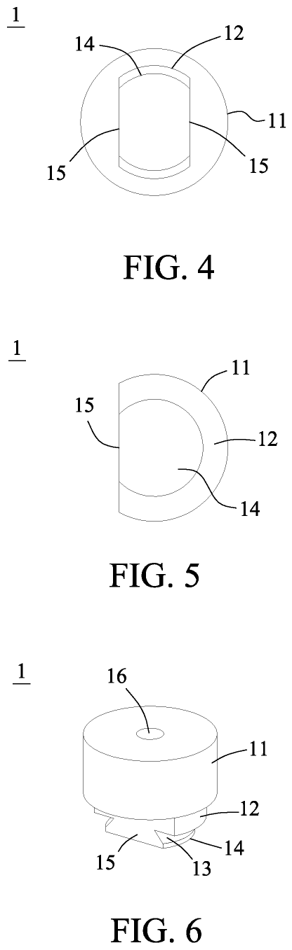

FIG. 1 and FIG. 2, the press-fit structure 1 may also be in the forms shown in FIG. 4 and FIG. 5. In FIG. 4, the limit stop portion 15 is in the form of a double-cut surface; in FIG. 5, the limit stop portion 15 is a single-cut surface and extends to the body 11 so as to meet actual application requirements.

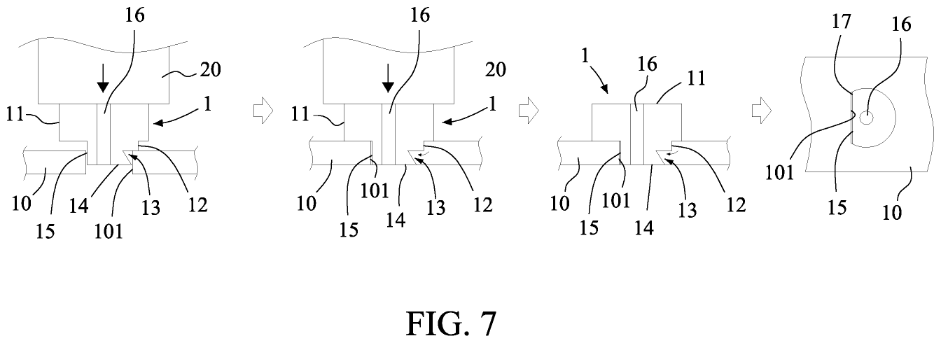

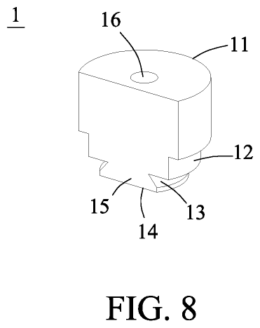

As shown in FIG. 6 to FIG. 10, in one embodiment of the present disclosure, a difference from the foregoing embodiments is that, the press-fit structure 1 further includes a fastening portion 16. The fastening portion 16 is provided at the body 11, and the limit stop portion 15 restricts a direction of the fastening portion 16 or a fastening direction of the fastening portion 16.

When assembled for use, the pressurizing portion 12 of the press-fit structure 1 is first arranged at the pressurizing position of the object 10. For example, the press-fit structure 1 is arranged at the pressurizing position on the upper surface of the object 10, such that the limit stop portion 15 is located at the corresponding stop portion 101 of the object 10. The body 11 of the press-fit structure 1 is pressurized by an external force using the pressurizing mold 20, such that the material of the object 10 is allowed to flow into or enter the material storage space 13, the object 10 is restricted by the restricting portion 14, and the corresponding stop portion 101 and the limit stop portion 15 are correspondingly stopped, so as to restrict the direction of the press-fit structure 1 and the fastening portion 16 by the limit stop portion 15. Thus, the press-fit structure 1 and the required object 10 are provided with a stable assembly effect, and fastening or being fastened (not shown) as needed with an associated object can be implemented using the fastening portion 16, thereby enabling the present disclosure to better meet actual application requirements.

In one embodiment of the present disclosure, when the material of the object 10 flows into or enters the material storage space 13, the object 10 is restricted by the restricting portion 14 and is correspondingly stopped by the corresponding stop portion 101 and the limit stop portion 15, such that the limit stop portion 15 and the corresponding stop portion 101 can define a fastening direction, a fastening position, an operating direction or an operating position of the fastening portion 16. Thus, the fastening portion 16 can fasten or be fastened (not shown) as needed with an associated object, thereby enabling the present disclosure to better meet actual application requirements.

In one embodiment of the present disclosure, the corresponding stop portion 101 and the limit stop portion 15 have a press-fit gap 17 in between, wherein the press-fit gap 17 may range between 0.00000000001 mm and 100 mm.

Thus, the pressurizing portion 12 of the press-fit structure 1 can be more easily arranged at the pressurizing position of the object 10.

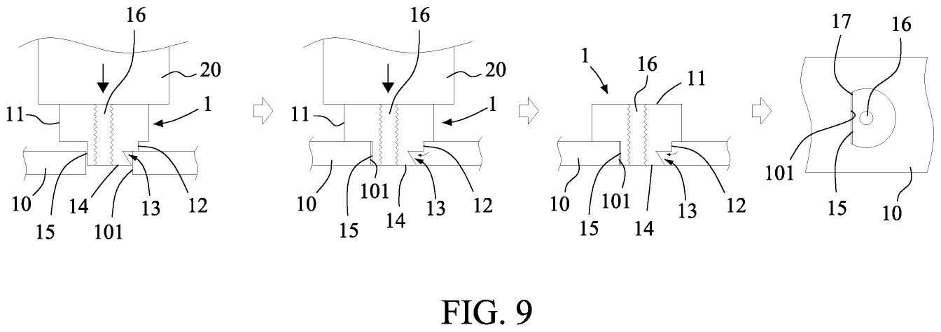

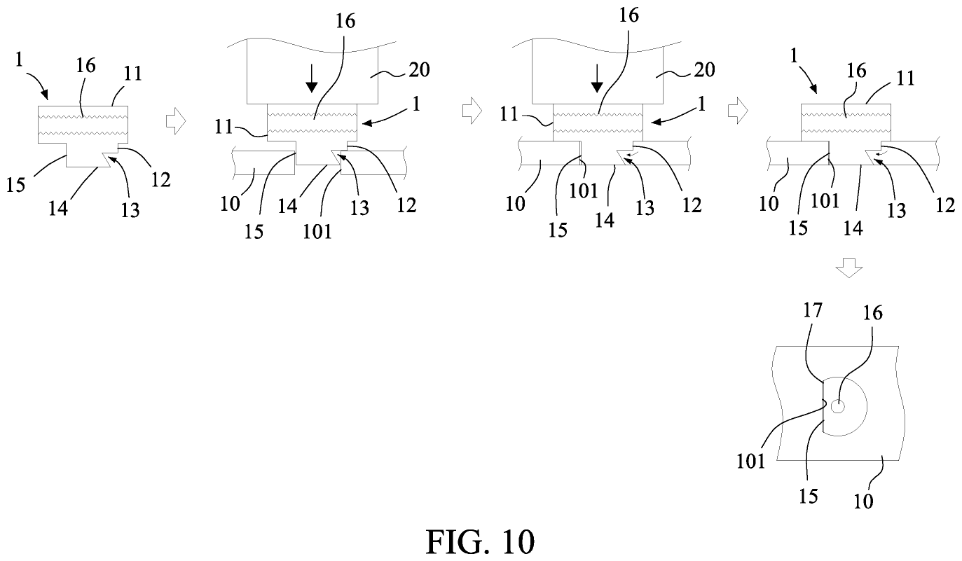

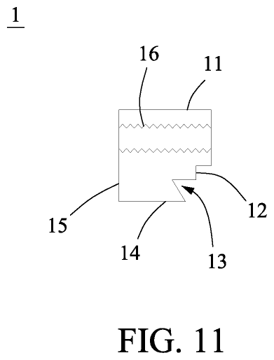

In one embodiment of the present disclosure, the fastening portion 16 may be a through hole (as shown in FIG. 6) or an inner thread (as shown in FIG. 9 and FIG. 10), and the fastening portion 16 may be longitudinally provided at the body 11 (as shown in FIG. 6 to FIG. 9), or the fastening portion 16 may be laterally provided at the body 11 (as shown in FIG. 10 and FIG. 11), thereby enabling the fastening portion 16 to meet actual application requirements.

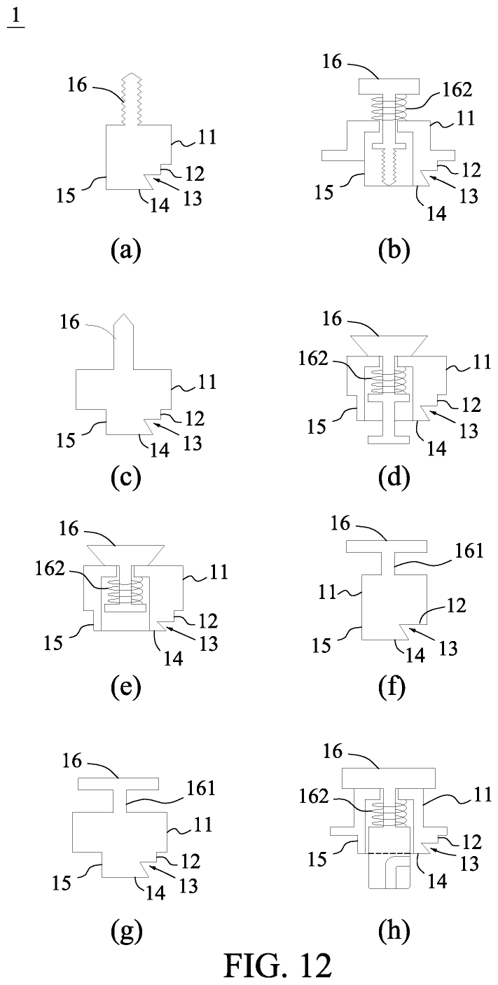

As shown in FIG. 12, in one embodiment of the present disclosure, a difference from the foregoing embodiments is that, the fastening portion 16 can be an outer thread (as parts a and b in FIG. 12), a column (as part c in FIG. 12), an outer fastener (as parts d, e, f and g in FIG. 12), an inner fastener (as part h in FIG. 12), an elastic fastener, a lateral fastener, or a fastening portion 16 having a neck 161 (as parts f and g in FIG. 12), thereby enabling the fastening portion 16 to meet actual application requirements.

Moreover, the fastening portion 16 is a fastener movably connected to the body 11, and an elastic element 162 (as parts b, d, e and h in FIG. 12) is provided between the fastening portion 16 and the body 11, thereby enabling the fastening portion 16 to meet actual application requirements.

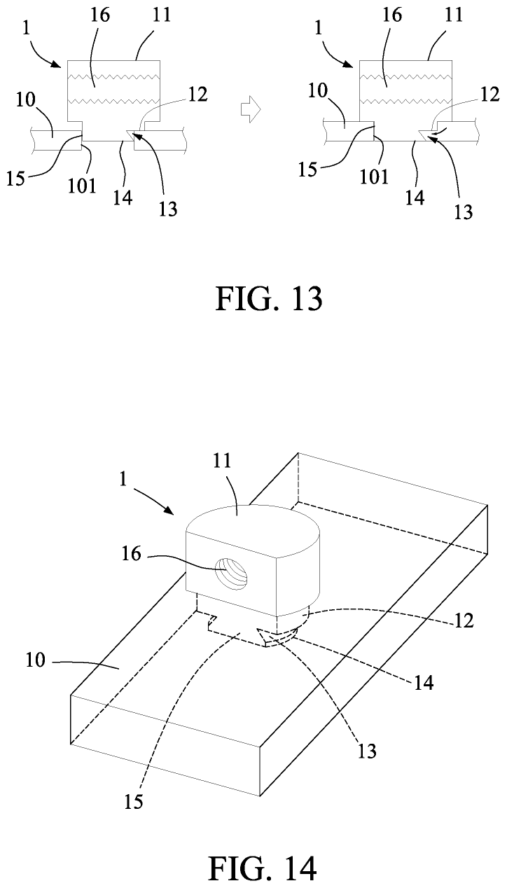

Referring to FIG. 13, in one embodiment of the present disclosure, a difference from the foregoing embodiments is that, the pressurizing portion 12 is greater than the material storage space 13, the material storage space 13 is smaller than the restricting portion 14, and the restricting portion 14 is smaller than the pressurizing portion 12. Thus, when assembled for use, the pressurizing portion 12 of the press-fit structure 1 is first arranged at the pressurizing position of the object 10, such that the limit stop portion 15 is located at the corresponding stop portion 101 of the object 10. The body 11 of the press-fit structure 1 is pressurized by an external force using the pressurizing mold 20, such that the material of the object 10 is allowed to flow into or enter the material storage space 13, the object 10 is restricted by the restricting portion 14, and the corresponding stop portion 101 and the limit stop portion 15 are correspondingly stopped, so as to restrict the direction of the press-fit structure 1 and the fastening portion 16 by the limit stop portion 15. Thus, the press-fit structure 1 and the required object 10 are provided with a stable assembly effect, and fastening or being fastened (not shown) as needed with an associated object can be implemented using the fastening portion 16, thereby enabling the present disclosure to better meet actual application requirements.

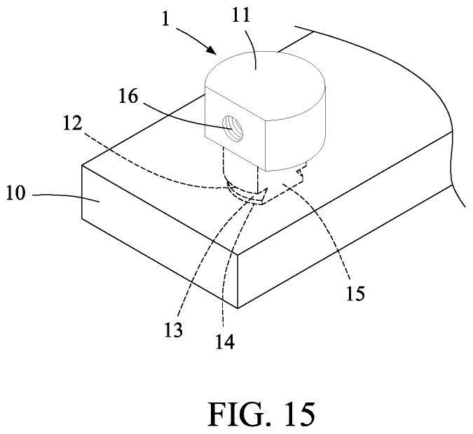

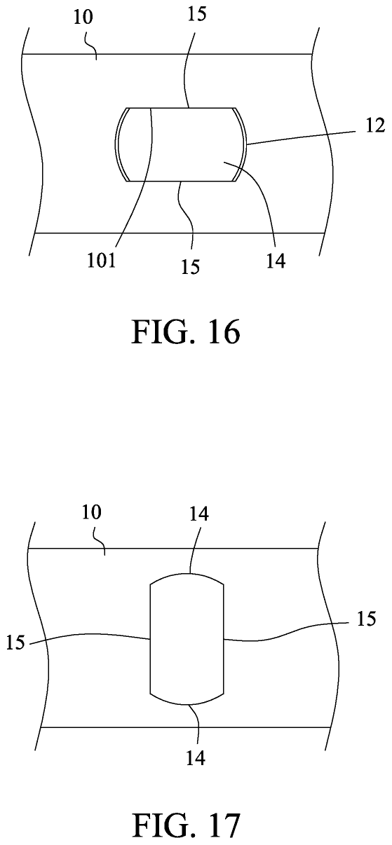

Referring to FIG. 14 to FIG. 17, in one embodiment of the present disclosure, a difference from the foregoing embodiments is that, the fastening portion 16 and the limit stop portion 15 can be in the same direction (as shown in FIG. 14), or the fastening portion 16 and the limit stop portion 15 can be in different directions (as shown in FIG. 15), and a gap between the limit stop portion 15 and the corresponding stop portion 101 is smaller than a gap between the restricting portion 14 and a part that is not the corresponding stop portion 101 in an opening of the object 10, and is for restricting a fastening direction or a fastened direction of the fastening portion 16 or restricting a true position or an angle of a fastening position or a fastened position of the fastening portion 16 (as shown in FIG. 16 and FIG. 17). Thus, once the press-fit structure 1 and the required object 10 are coupled, the fastening portion 16 can be located at a required fastening or fastened position, thereby enabling the present disclosure to better meet actual application requirements.

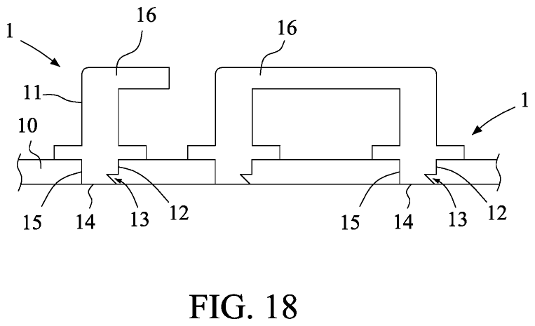

Referring to FIG. 18, in one embodiment of the present disclosure, a difference from the foregoing embodiments is that, the fastening portion 16 of the press-fit structure 1 can be an L-shaped or horseshoe-shaped handle, thereby enabling the present disclosure to better meet actual application requirements.

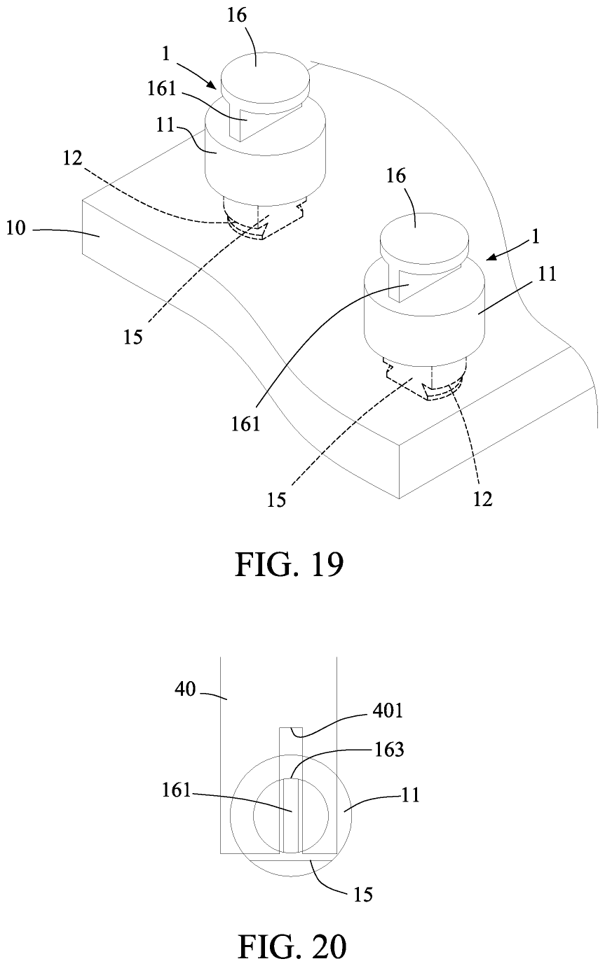

As shown in FIG. 19 and FIG. 20, in one embodiment of the present disclosure, a difference from the foregoing embodiments is that, the neck 161 of the fastening portion 16 is capable of restricting a fastening direction of a fastening counterpart 40. When the press-fit structure 1 is arranged at the object 10, in addition to using the limit stop portion 15 to restrict the direction of the press-fit structure 1 and the fastening portion 16, the neck 161 can be further used to restrict the fastening direction of the fastening counterpart 40, thereby enabling the fastening portion 16 to meet actual application requirements.

In one embodiment of the present disclosure, the neck 161 has a limit portion 163. The limit portion 163 is used for restricting a fastening direction of a corresponding limit portion 401 of the fastening counterpart 40, thereby enabling the fastening portion 16 to meet actual application requirements.

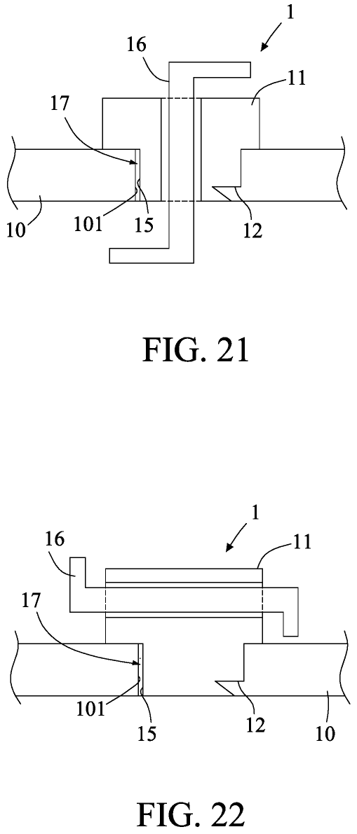

As shown in FIG. 21 and FIG. 22, in one embodiment of the present disclosure, a difference from the foregoing embodiments is that, the fastening portion 16 of the press-fit structure 1 is movably disposed at the body 11, and when the press-fit structure 1 is arranged at the object 10 via the pressurizing portion 12, the corresponding stop portion 101 of the object 10 and the limit stop portion 15 have a press-fit gap 17 in between. Thus, the pressurizing portion 12 of the press-fit structure 1 can be more easily arranged at the pressurizing position of the object 10.

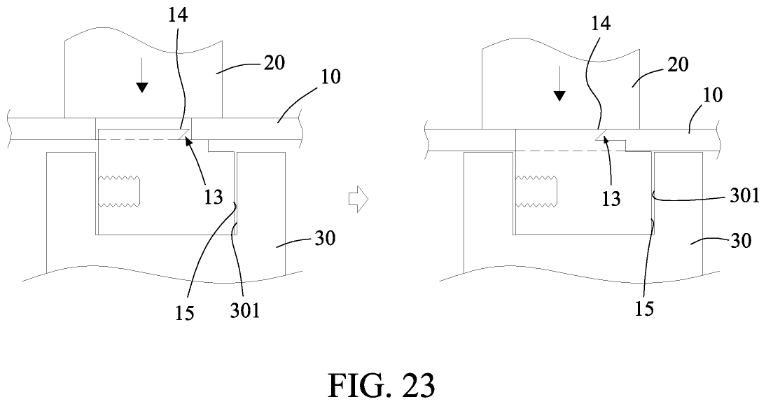

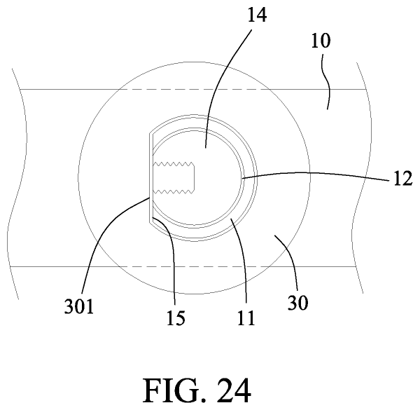

Referring to FIG. 23 and FIG. 24, in one embodiment of the present disclosure, a difference from the foregoing embodiments is that, the limit stop portion 15 is for correspondingly stopping against a corresponding stop portion 301 of a mold 30, so as to restrict a restriction direction of the press-fit structure 1 by the limit stop portion 15.

When assembled for use, the limit stop portion 15 of the press-fit structure 1 is correspondingly stopped against the corresponding stop portion 301 of the mold 30, and the object 10 is arranged at the pressurizing position of the press-fit structure 1, such that the limit stop portion 15 is located at the corresponding stop portion 101 of the object 10. The body 11 of the press-fit structure 1 is pressurized by an external force using the pressurizing mold 20, such that the material of the object 10 is allowed to flow into or enter the material storage space 13, the object 10 is restricted by the restricting portion 14, and the corresponding stop portion 101 and the limit stop portion 15 are correspondingly stopped, so as to restrict the direction of the press-fit structure 1 by the limit stop portion 15, thereby enabling the present disclosure to better meet actual application requirements.

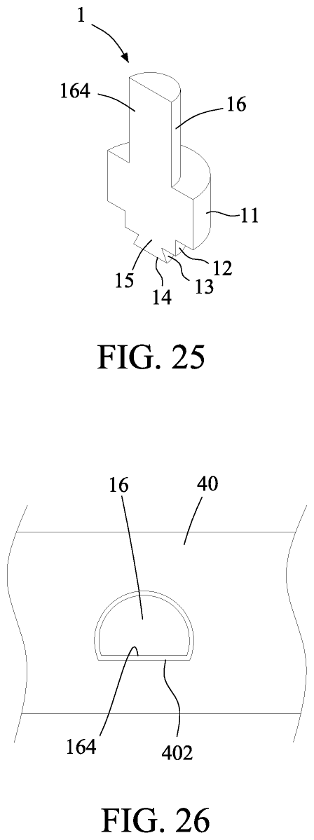

Referring to FIG. 25 and FIG. 26, in one embodiment of the present disclosure, the press-fit structure 1 further includes a fastening portion 16. The fastening portion 16 includes an anti-rotation portion 164, which is for restricting an anti-rotation direction or a fastening direction of a corresponding anti-rotation portion 402 of the fastening counterpart 40, thereby enabling the present disclosure to better meet actual application requirements.

The present disclosure is described by way of the preferred embodiments above. A person skilled in the art should understand that, these embodiments are merely for describing the present disclosure and are not to be construed as limitations to the scope of the present disclosure. It should be noted that all equivalent changes, replacements and substitutions made to the embodiments are encompassed within the scope of the present disclosure. Therefore, the scope of legal protection of the present disclosure should be defined by the appended claims.

What is claimed is:

1. A press-fit structure, comprising a body, a pressurizing portion, a material storage space, a restricting portion and a limit stop portion; wherein, the pressurizing portion, the material storage space, the restricting portion and the limit stop portion are provided at the body, the pressurizing portion is for applying a pressure on an object to cause a material of the object to flow into or enter the material storage space, the press-fit structure restricts the object by the restricting portion, and a restriction direction of the press-fit structure is restricted by the limit stop portion.

2. The press-fit structure according to claim 1, further comprising a fastening portion, wherein the fastening portion is provided at the body, and the limit stop portion restricts a direction of the fastening portion or a fastening direction of the fastening portion.

3. The press-fit structure according to claim 1, further comprising a fastening portion, wherein the fastening portion is a through hole, an inner thread, an outer thread, a column, an outer fastener, an inner fastener, an elastic fastener, a lateral fastener, or a fastening portion having a neck, or the fastening portion is a fastener movably connected to the body.

4. The press-fit structure according to claim 1, wherein the object has a corresponding stop portion, and the corresponding stop portion correspondingly stops against the limit stop portion.

5. The press-fit structure according to claim 1, further comprising a fastening portion, wherein the object has a corresponding stop portion, and the limit stop portion and the corresponding stop portion define a fastening direction, a fastening position, an operating direction or an operating position of the fastening portion.

6. The press-fit structure according to claim 1, wherein the object has a corresponding stop portion, and the corresponding stop portion and the limit stop portion have a press-fit gap in between.

7. The press-fit structure according to claim 1, wherein the limit stop portion is a is a single-cut surface, a double-cut edge, a symmetrical cut edge, a multi-cut surface, a convex portion, a concave portion, a flat portion, an inclined portion, a curved portion, a toothed portion or a stepped portion.

8. The press-fit structure according to claim 1, wherein the pressurizing portion is greater than the material storage space, the material storage space is smaller than the restricting portion, and the restricting portion is smaller than the pressurizing portion.

9. The press-fit structure according to claim 1, further comprising a handle.

10. The press-fit structure according to claim 1, wherein the object has a corresponding stop portion, and a gap between the limit stop portion and the corresponding stop portion is smaller than, greater than or equal to a gap between the restricting portion and a part that is not the corresponding stop portion in an opening of the object, and is for restricting a fastening direction or a fastened direction of a fastening portion or restricting a true position or an angle of a fastening position or a fastened position of a fastening portion.

11. The press-fit structure according to claim 1, further comprising a fastening portion, wherein the fastening portion has a neck, and the neck has a limit portion for restricting a fastening direction of a corresponding limit portion of a fastening counterpart.

12. The press-fit structure according to claim 1, further comprising a fastening portion, wherein the fastening portion has a limit portion for restricting a fastening direction of a corresponding limit portion of a fastening counterpart.

13. The press-fit structure according to claim 1, wherein the limit stop portion is for correspondingly stopping against a corresponding stop portion of a mold, so as to restrict a restriction direction of the press-fit structure by the limit stop portion.

14. The press-fit structure according to claim 1, further comprising a fastening portion, wherein the fastening portion has an anti-rotation portion, which is for restricting an anti-rotation direction or a fastening direction of a corresponding anti-rotation portion of a fastening counterpart.

15. A press-fit method for a press-fit structure, for press-fitting the press-fit structure of claim 1, the method comprising: first arranging the pressuring portion on a pressurizing position of the object such that the limit stop portion is located at a corresponding stop portion of the object or a mold, and pressurizing the press-fit structure by an external force such that the press-fit structure is press-fitted at the object and limited by the limit stop portion.
